(19) United States
(12) Patent Application Publication
(10) Pub. No.: US 2014/0310143 A1
(43) Pub. Date: Oct. 16, 2014

(54) Configurable Non-Numeric Quantity Data Feed Display

(71) Applicant: TRADING TECHNOLOGIES INTERNATIONAL, INC., Chicago, IL (US)

(72) Inventors: Scott F. Singer, Green Oaks, IL (US); Brian J. Buck, Livermore, CA (US)

(73) Assignee: Trading Technologies International, Inc., Chicago, IL (US)

(21) Appl. No.: 13/860,932

(22) Filed: Apr. 11, 2013

(51) Int. Cl. G06Q 40/04

(52) U.S. Cl. CPC G06Q 40/04
USPC 705/37

(57) ABSTRACT

A tool and method for transmitting and displaying market depth information associated with a tradeable object trading in a market is disclosed. The tool and method provide a mechanism by which market depth information may be withheld when the change in market depth information is not sufficiently significant. In response to transmitting market depth information, the market depth information is displayed using indicators associated with range instead of a value.

### CROSS REFERENCE TO RELATED APPLICATIONS

This patent document is related to U.S. patent application Ser. No. 09/289,550, filed on Apr. 9, 1999, now U.S. Pat. No. 7,212,999, titled “User Interface for an Electronic Trading System,” the entire contents of which are fully incorporated herein by reference.

### BACKGROUND

An electronic trading system generally includes a trading device in communication with an electronic exchange. The electronic exchange distributes information about a market, such as prices and quantities. The information is generally received by the trading device. The trading device sends messages, such as messages related to orders. The messages are generally received by the electronic exchange. The electronic exchange attempts to match quantity of an order with quantity of one or more contra-side orders.

Electronic exchanges provide useful market depth information which may, in turn, be displayed to the user (e.g. a trader). However, having to constantly transmit market depth information can place a burden on network traffic and encroach on bandwidth limits. Additionally, a display updating market depth information in real time can change too rapidly for the human eye to comprehend. As a result, transmitting the market depth information puts a strain on valuable bandwidth without a benefit to the user.

### BRIEF DESCRIPTION OF THE FIGURES

Examples for a configurable non-numeric quantity data feed display are disclosed with reference to the following drawings.

FIG. 1 illustrates a block diagram representative of an example electronic trading system in which examples may be employed.

FIG. 2 illustrates a block diagram of another example electronic trading system in which an exemplary configurable non-numeric quantity data feed display may be employed.

FIG. 3 illustrates a block diagram of an example computing device, which may be used to implement the disclosed embodiments.

FIGS. 4A and 4B illustrate flow diagrams of exemplary processes executed to update the market depth display.

FIGS. 5A and 5B illustrate a prior art display of market depth information.

FIGS. 6A and 6B illustrate an exemplary display of market depth information.

FIG. 7 illustrates a display of market depth information by one continuous indicator.

FIG. 8 illustrates a display of market depth information for two tradeable objects.

FIG. 9 illustrates a display of market depth information in combination with an indication of lowest limit for fulfilling an order.

FIG. 10 illustrates a display of market depth information in combination with a user indicator.

FIG. 11 illustrates a display of market depth information using a static indicator and a quantity key.

FIG. 12 illustrates a display of market depth information using a static indicator per user and a quantity key.

FIG. 13 illustrates a display of market depth information using a static indicator represented by symbols and a quantity key.

FIG. 14 illustrates a display of market depth information including a user's position in queue.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments generally relate to transmitting and displaying market depth information. The market depth information, for example, may be associated with a tradeable object trading in a market. The market depth may refer to the aggregate quantity available for all orders at the same price level.

Exchanges may generate and provide market depth information that changes and updates rapidly. The market depth information received from the exchange is, in turn, formatted and displayed for use by the user (e.g., a trader, a risk administrator, etc.). Transmitting market depth information can place a burden on network traffic and encroach on bandwidth limits. Additionally constant updates to the trading device display of market depth information may be incomprehensible to the user. For example, the market depth information will change at a rate that the human eye cannot process. Accordingly, effective control of the frequency and amount of market information displayed through an electronic trading system is advantageous.

The described examples may alleviate these problems. For example, the configurable non-numeric quantity data feed display may transmit market depth information Another exemplary Configurable Non-Numeric Quantity Data Feed Display provides a mechanism by which market data will not be transmitted unless a defined threshold for the change in market depth quantity is met. In response to transmitting the market depth data, the display will be updated to reflect the changes in market depth based on configured display parameters.

In an embodiment, a method for displaying market depth associated with a tradeable object trading in a market includes dynamically displaying, by an electronic display device, a plurality of price levels associated with the tradeable object. In the method, a quantity threshold parameter is set, by a computing device. The order quantity threshold parameter is associated with a range of tradeable object quantities. The method determines, by the computing device, if the quantity threshold parameter is exceeded. In response to exceeding the quantity threshold parameter, the display is dynamically updated, by the electronic display device. The display dynamically updates, by the electronic display device, one or more quantity range indicators adjacent to one or more of the plurality of price levels. Each of the one or more quantity range indicators represents a range of the market depth at a given pricing level.

Although this description discloses examples of Configurable Non-Numeric Quantity Data Feed Display including, among other components, software executed on hardware, it should be noted that the examples are merely illustrative and should not be considered as limiting. For example, any or all of these hardware and software components may be exclusively hardware, exclusively software, exclusively firmware, or any combination of hardware, software, and/or firmware. Accordingly, certain embodiments may be implemented in other ways.

### I. Example Electronic Trading System

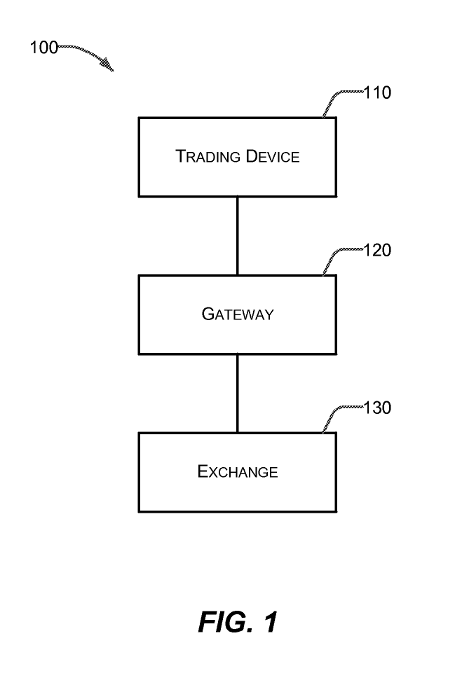

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The phrase “in communication” also includes wired and wireless communications. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a tradeable object at an instance in time (since the inside market may vary over time). Market depth may refer to quantities available at the inside market. Market depth also or alternatively may refer to quantities at prices away from the inside market. A gap in market depth may be present where no quantity is available for a price level.

A tradeable object is anything which may be traded. For example, a quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, and/or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that may include a trade order. A trade order may be a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 includes a desktop computer, hand-held device, laptop, server, a portable computing device, a trading terminal, an embedded trading system, a workstation, an algorithmic trading system such as a “black box” or “grey box” system, cluster of computers, or a combination thereof. Additionally or alternatively, the trading device 110 includes a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions stored in a computer readable medium and executable by a processor. A computer readable medium may include volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a party, such as a manufacturer, developer, or publisher, on one or more CDs, DVDs or other media, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As an additional or alternative example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets. An order message also or alternatively may be shared or otherwise available through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system.

The gateway 120 may include one or more electronic computing platforms. For example, the gateway 120 may implemented as one or more desktop computers, hand-held devices, laptops, servers, a portable computing devices, a trading terminals, embedded trading systems, workstations with a single or multi-core processor, algorithmic trading systems such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may be an electronic exchange. The exchange 130 may include separate entities, some of which list and/or administer tradeable objects and others which receive and match orders, for example. The exchange 130 may include one or more electronic communication networks (“ECN”), for example.

The exchange 130 may include an electronic matching system, such as a computer, server, or other computing device, which is adapted to administer trading and matching of orders for tradeable objects offered for trading by the exchange. The exchange 130 is adapted to receive order messages and match contra-side trade orders to buy and sell tradeable objects. Unmatched trade orders may be listed for trading by the exchange 130. The trade orders may, for example, include trade orders received from the trading device 110 or other devices in communication with the exchange 130. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 publishes a data feed. The data feed may be received by subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### II. Expanded Example Electronic Trading System

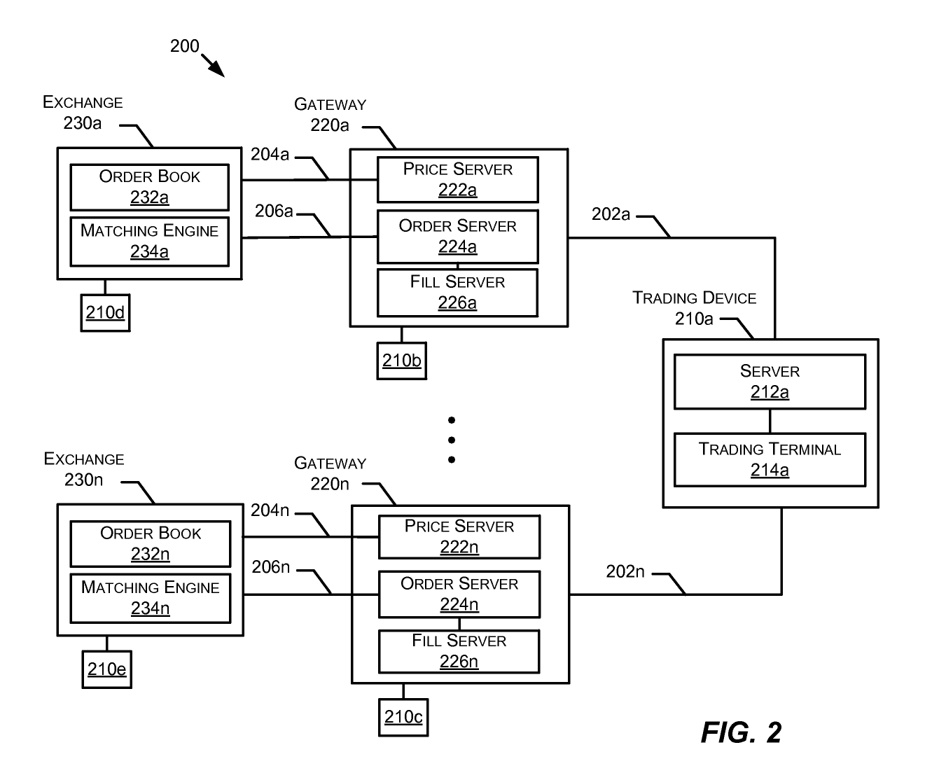

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may include a trading screen and communicate commands to the server 212a for further processing. For example, a trading algorithm is deployed to the server 212a for execution. The algorithm may be based on market data. The server 212a may execute the trading algorithm without further or with minimized input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates, enables or is otherwise operable for communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradeable objects. The order server 224a may process order data. Order data is data related to a user's trade orders. For example, order data includes order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there are two communication networks connecting the gateway 220a and the exchange 230a. The network 204a may be used to communicate market data to the price server 222a. In some instances, the exchange 230a includes this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book includes data relating to a market for a tradeable object, such as the inside market, market depth at various price levels, the last traded price, and the last traded quantity. The matching engine 234a may match contra-side bids and offers. For example, the matching engine 234a may execute one or more matching algorithms for matching contra-side bids and offers, or otherwise executing a trade between at least two orders. A sell order is contra-side to a buy order with the same price. A buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, processes this data. For example, the data is displayed to a user. In another example, the data is utilized in a trading algorithm to determine whether a trade order should be submitted to the exchange 230a. The trading device 210a may prepare and send an order message to the exchange 230a.

In certain embodiments, the gateway 220a is integral with the trading device 210a. For example, the components of the gateway 220a are integral with the same computing platform as the trading device 210a. As another example, the functionality of the gateway 220a may be performed by components of the trading device 210a. In certain embodiments, the gateway 220a is not present. Such an arrangement may occur when the trading device 210a has been adapted to communicate directly with the exchange 230a and does not need to utilize the gateway 220a as an intermediary to communicate with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges. Such an arrangement may, for example, allow one or more trading devices 210a to trade at more than one exchange (and/or provide redundant connections to multiple exchanges).

### III. Example Computing Device

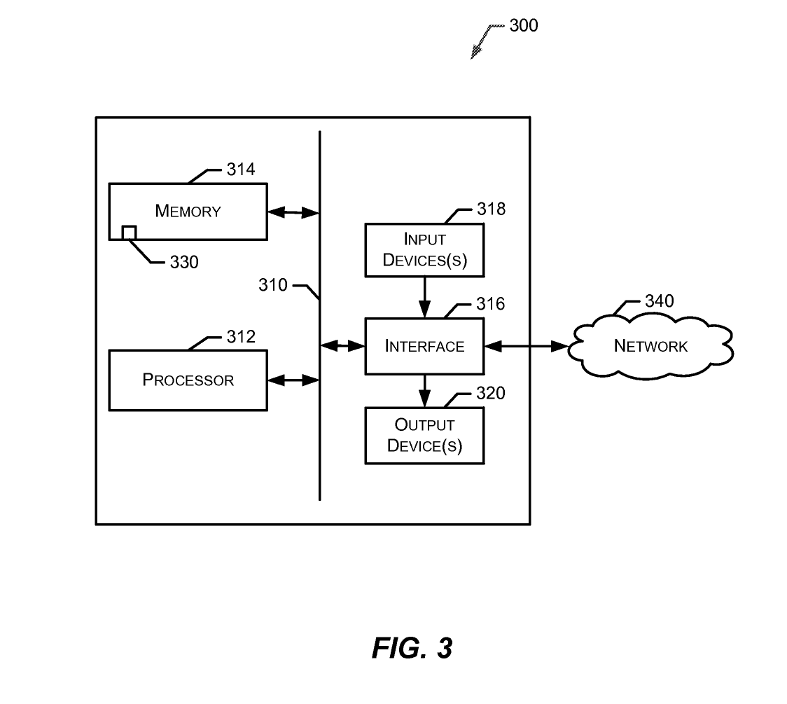

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media. The memory 314 may include any desired type of mass storage device including hard disk drives, optical media, magnetic tape or disk, etc.

The memory 314 may include one or more memory devices. For example, the memory 314 includes local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

### IV. Configurable Non-Numeric Quantity Data Feed Display

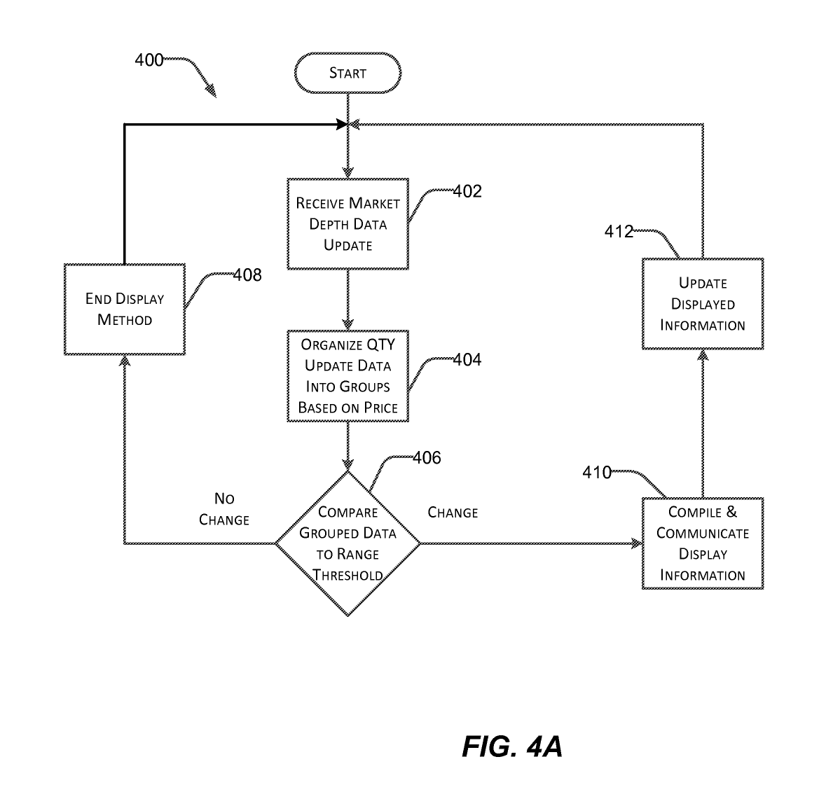

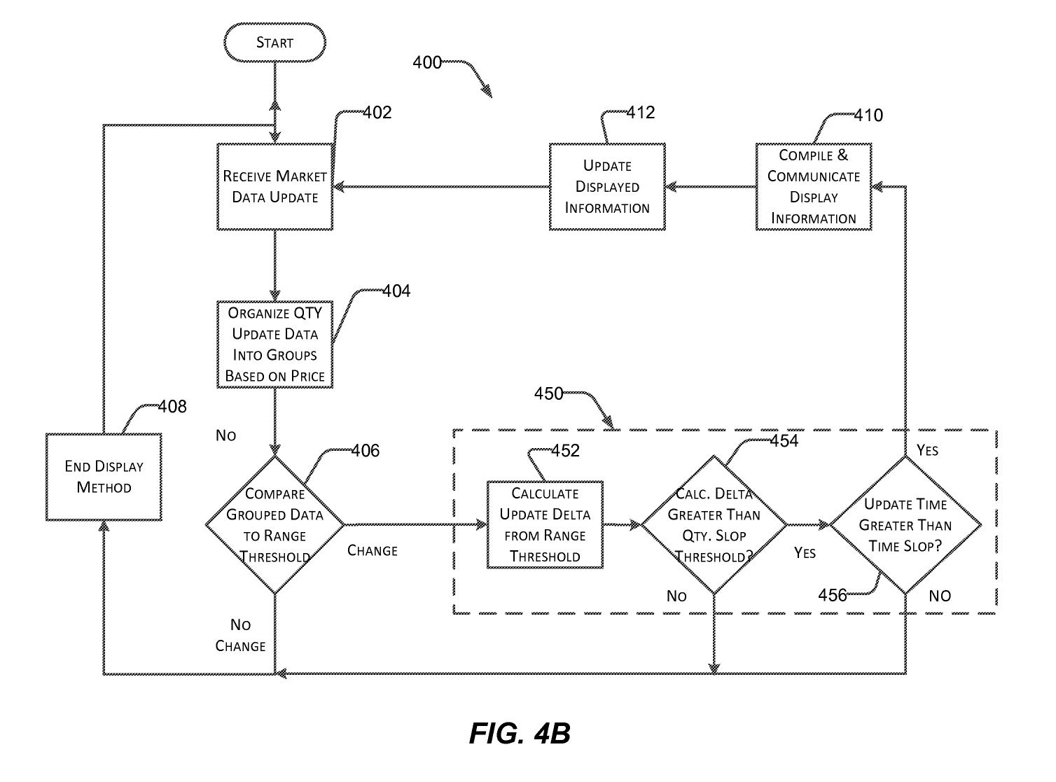

FIGS. 4A and 4B are flow diagrams detailing the acts, steps and functions that may be implemented by the exemplary configurable non-numeric quantity data feed display method disclosed herein. FIG. 4A illustrates an example of a configurable non-numeric quantity data feed display method 400 that may be implemented by any of an apparatus (e.g., the trading device 110, gateway 120, or electronic exchange 130 of FIG. 1), a system, a computer program, a computer readable medium, or a combination thereof. The method 400 is configured to efficiently display market depth and/or market depth update information related to a detected or calculated change in market depth associated with a tradeable object. Upon determination of a change in market depth, the method 400 may generate an update to the configurable non-numeric quantity data feed display for presentation to the user.

At block 402, the exemplary method 400 receives market data in the form of a market depth update. For example, the received market depth update may include quantity data for multiple price levels. In operation, a computing device such as the trading device 110, gateway 120, and/or exchange 130 shown in FIG. 1 may receive the market depth update information via communication network such as the network 202 shown in FIG. 2. As used herein, the act of receiving market depth information may include data processing and acquisition actions such as collecting, generating, aggregating, acquiring, or otherwise obtaining market data.

At block 404, the method 400 analyzes and organizes the quantity and pricing data contained within the received market depth information. The organized quantity data describes the quantity of tradeable objects at each price level grouped according to pre-defined quantity ranges such as, for example, the quantity ranges shown in Table 1. Each of the example quantity ranges (e.g., 0-10 and 11-100 of Table 1) is associated with, and identified by, a quantity indicator (e.g., Indicator 1-Indicator 4 of Table 1). The quantity indicator may be a color, a pattern, a non-numeric symbol or other unique identifier associated with the quantity range and group. In one example, the quantity range values for each group may be preset values organized along a logarithmic scale. In another example, the quantity range values may be user-defined and vary based on, for example, the time of day or other event-based triggers such as a release of employment statistics or trading volume. By grouping and organizing the quantity and associated pricing data in the disclosed manner, a single quantity indicator may be utilized to identify a wide range of quantities. Because a single quantity indicator represents multiple quantities, the method 400 provides a flexible mechanism by which market depth information can be presented without the continuous necessity of updating the display information for each change in available quantity. In operation, the decreased need to update the quantity indicator results in a decrease in message size and a corresponding increase in available communication bandwidth.

TABLE 1
Example configurable non-numeric quantity
data feed ranges and indicators.

| Group | Quantity Range | Quantity Indicator |
|---|---|---|
| 1 | 0-10 | Indicator 1 |
| 2 | 11-100 | Indicator 2 |
| 3 | 101-1000 | Indicator 3 |
| 4 | 1001+ | Indicator 4 |

At block 406, the method 400 compares the organized quantity and price data (from block 404) to one or more of the high and low values that define each quantity range. If the quantity data associated with each of the price levels contained within the latest received market depth update falls within the current quantity range (i.e., the quantity data is between the high and low values and the quantity indicator remains unchanged), method 400 may end as indicated at block 408 and control may subsequently return to block 402 to receive additional market depth updates. On the other hand, if the quantity data associated with one of the price levels contained within the latest received market depth update falls outside the current quantity range (i.e., the quantity data falls outside the high and low values resulting in a change in the quantity indicator), then the method 400 may proceed to block 410. The high and low values that define each quantity range constitute quantity threshold parameters that can be adjusted based on, for example, the desired display behavior of the corresponding quantity indicator, the liquidity of the market and bandwidth available to communicate display updates.

At block 410, the method 400 compiles and/or aggregates all of the previously determined status change information associated with the received market depth information. For example, if the latest received market depth update is determined to include a status change at one (1) price level and no changes at nine (9) other price levels, then the status change information associated with the one price level may be utilized to update the display portion of the computing device while the data associated with the remaining nine price levels is discarded or otherwise not used to update the display. The compiled status change information may be communicated locally to update a display portion of the computing device. In another example, the compiled status change information may be communicated via the network interface 316 to one or more computing devices operating in connection with the network 340 (see FIG. 3).

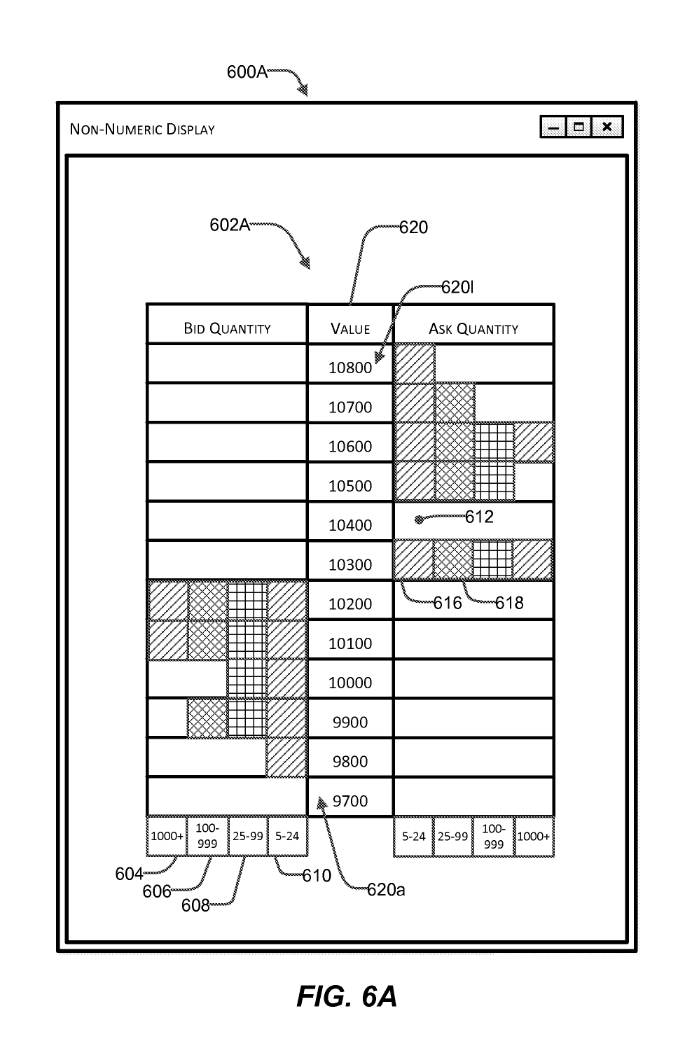

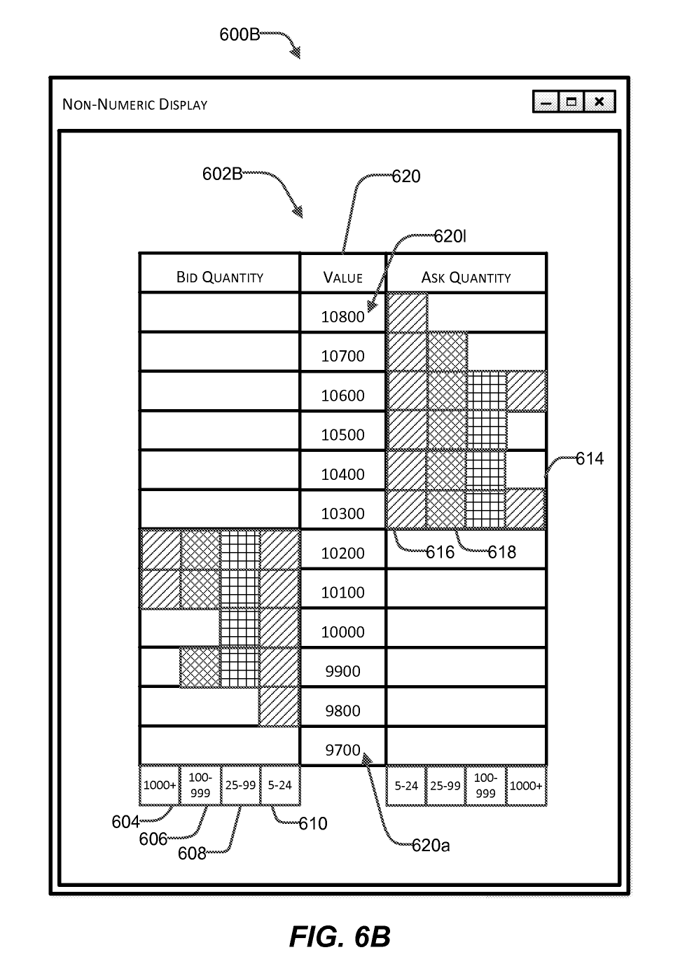

At block 412, communicated status change information may be used to update the displayed quantity indicator as shown in, for example, FIGS. 6A and 6B. The method 400 continues and control returns to block 402 to receive additional market data.

FIG. 4B illustrates another example of the configurable non-numeric quantity data feed display method 400 configured to include a slop routine 450. The method 400 and the included slop routine 450 may be implemented by any of an apparatus (e.g., the trading device 110, gateway 120, or electronic exchange 130 of FIG. 1), a system, a computer program, a computer readable medium, or a combination thereof. As shown in FIG. 4A, the method 400 compares the organized quantity and price data to one or more of the high and low values that define each quantity range (see block 406). Upon determination that the latest received market depth update contains quantity data at one or more price levels that falls outside the current quantity range resulting in a change in the quantity indicator, then the method 400 may proceed to the slop routine 450 at block 452.

At block 452, the slop routine 450 portion of the method 400 calculates a delta or change between the quantity data contained within the latest received market depth update and the quantity threshold parameters defined by the high and low values that make up the quantity range. The calculated delta represents an absolute value amount beyond which the quantity data contained within the latest received market depth update exceeds either the high and low values defined by the quantity range.

At block 454, the slop routine 450 portion of the method 400 determines whether the calculated delta is greater than a quantity slop threshold. The quantity slop threshold describes how much the quantity can change between adjacent market depth quantity ranges before an update to the display is generated. The quantity slop threshold may be predefined or otherwise user-configurable. If the calculated delta is below the quantity slop parameter, the slop routine 450 and method 400 may end as indicated at block 408 and control may subsequently return to block 402 to receive additional market data. If the calculated delta equals or exceeds the quantity slop threshold the method may proceed to block 456. In another embodiment, when the slop routine 450 and method 400 determine that the calculated delta is below the quantity slop parameter a timer or other timing mechanism (not shown) may be implemented. The example timer or timing mechanism may operate as a countdown between market data updates to ensure that the displayed data does not become stale or out-of-date. For example, before concluding the method 400 and discarding the data associated with the calculated delta as indicated at block 408, the method 400 may hold the data until either a market data update is received or the timer has run down. If a market data update is received before the timer expires, the held data may be discard and the method 400 resumes or restarts at block 402. However, if the timer expires and a new market data update has not been received, the method 400 may override the result of block 454 and display the held data in order to ensure that the display remains up-to-date.

At block 456, the slop routine 450 portion of the method 400 calculates the time interval between successive display updates. For example, the computing device determines the amount of time between the last display update and the latest received market depth update. The determined time interval is then compared to a time slop parameter. The time slop parameter defines the minimum time interval allowed between successive display updates. The length of time associated with the time slop parameter may be adjusted to dampen or otherwise control to frequency at which display updates are propagated in an active or fast-moving market. If calculated time interval is less than the time slop parameter, the method 400 may end as indicated at block 408 and control may subsequently return to block 402 to receive additional market data. If the calculated time interval equals or exceeds the time slop parameter the method 400 may proceed to block 412 as described in connection with FIG. 4A.

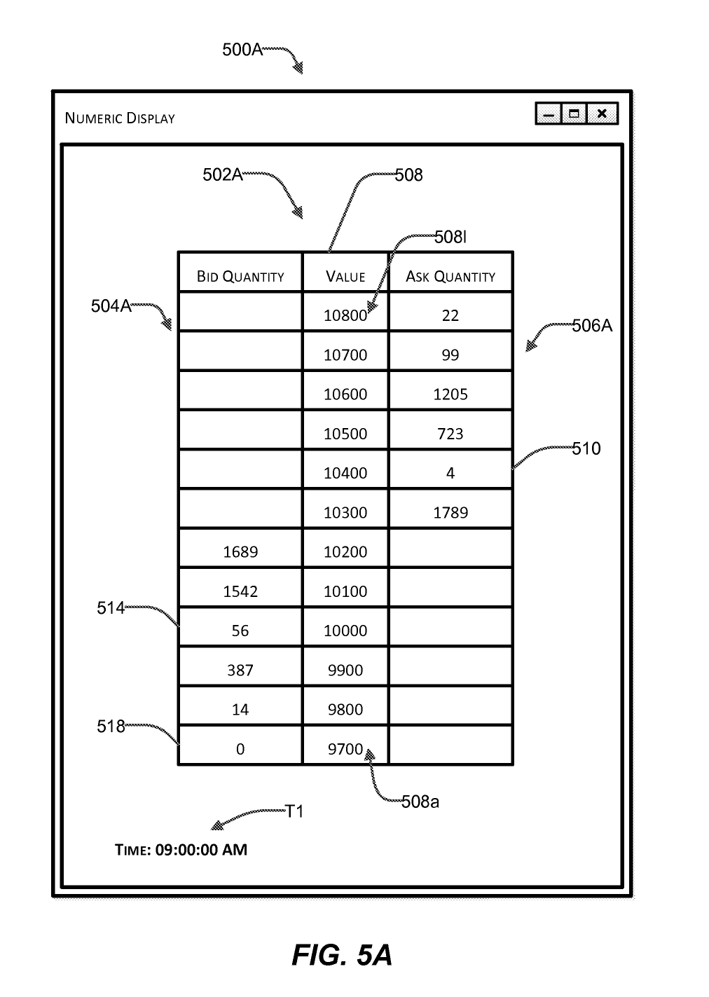

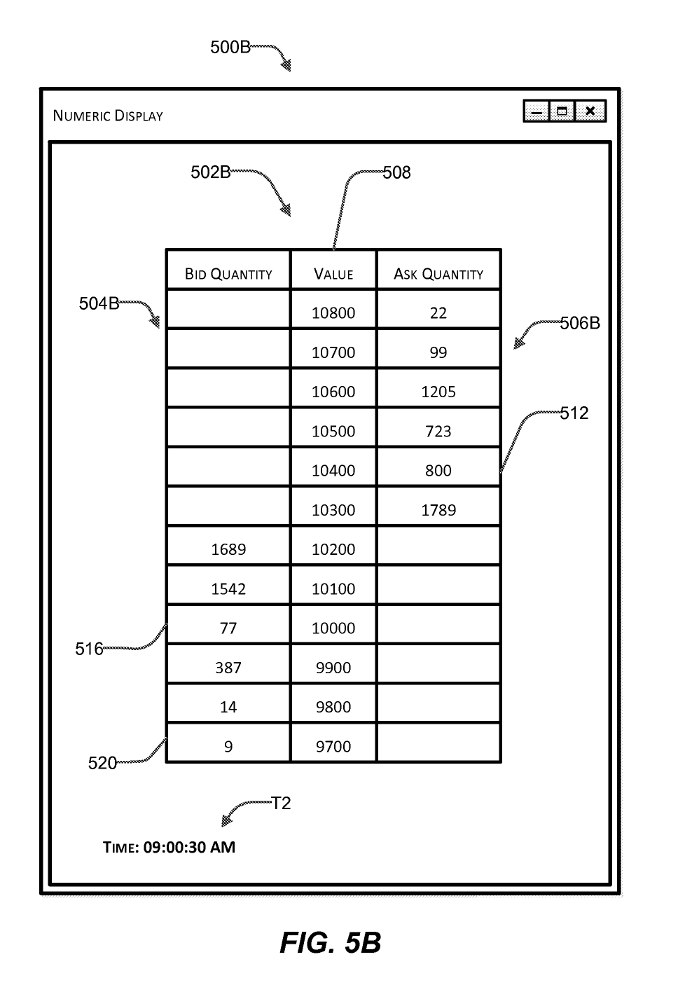

FIGS. 5A and 5B illustrate numeric quantity data feed displays 500A and 500B configured to represent market depth information 502A and 502B using traditional alphanumeric values. The example numeric quantity data feed displays 500A and 500B each respectively includes: a buy side quantity display axis or bid axis 504A and 504B; a sell side quantity display axis or ask axis 506A and 506B; and a value axis 508 arranged therebetween. The value axis may, in one example, represent prices, differences between prices as a function of time, or any representation of worth. In this way, the numeric market depth information shown in FIGS. 5A and 5B is displayed in a numeric format to create a market depth consisting of quantity values. In one example, the individual price levels 508a to 508l comprising the value axis 508 align with corresponding quantities displayed within the bid axis 504 and the ask axis 506. FIG. 5A depicts a first set of numeric market depth information 502A for a tradeable object at a first point in time T1. FIG. 5B depicts a second set of numeric market depth information 502B for the same tradeable object at a second (later) point in time T2. A comparison of FIG. 5A to FIG. 5B shows that at the price level of 10400, the quantity available for sale at that price level increases from an ask quantity 510 of 4 at time T1 to an ask quantity 512 of 800 at time T2. If, for example, the change in the ask quantity occurred in single unit increments, updating and displaying the changes in quantity could have required the communication of 796 quantity updates. The need for a large number of quantity updates results in a reduction in available communication bandwidth.

FIGS. 6A and 6B illustrate exemplary configurable non-numeric quantity data feed displays 600A and 600B configured to represent market depth information 602A and 602B using configurable non-numeric quantity range indictors. In particular, FIGS. 6A and 6B illustrate an example display for presenting the market depth information of FIGS. 5A and 5B, respectively, with non-numeric market depth quantity range indicators. The exemplary non-numeric market depth quantity range indicators may be configurable to symbols, patterns, colors or other indicia that may be assigned to a quantity range. FIGS. 6A and 6B illustrate four market depth quantity ranges indicators by the reference numerals 604-610. The mirror image of the quantity ranges indicators are displayed for contra-side quantities. In certain examples, the four market depth quantity ranges 604-610 may be removed allowing for the display of an additional price level 620n to the displayed price levels 620a to 6201 comprising the value axis 620. FIG. 6A displays no enabled market depth quantity range indicators 612 at a price level of 10400 to represent that there is a market depth of between 0-4. FIG. 6B displays three (3) enabled market depth quantity range indicators generally identified by the reference identifier 614 to represent an available quantity of between 100-999 at a price level of 10400. The exemplary market depth quantity range indicators are updated when the determined available quantity of the tradeable object changes from one market depth quantity range to another. For example, in FIG. 6A, when the available quantity at a price level of 10300 increases from a quantity range 616 defined by an upper limit of 24 to a quantity range 618 defined by a lower limit of 25, the non-numeric quantity range indicator associated with the quantity range of 25-99 is activated or enabled. Similarly, if the quantity decreases sufficiently, a non-numeric quantity range indictor can be deactivated to indicate less available quantity.

In an additional or alternative example, market depth update information will not be transmitted in response to changes in market depth that will not impact the displayed market depth quantity range indicators. Market depth changes that fall within a configured market depth quantity range will not trigger transmission of updated market depth information. For example, as the bid quantity 514 increases from 56 (in FIG. 5A) to a bid quantity 516 of 77 (in FIG. 5B), the non-numeric market depth quantity range indicator remains unchanged because both of the quantities 56 and 77 fall within the quantity range 608 shown in FIGS. 6A and 6B. Because there is no shift between adjacent market depth quantity ranges (e.g., quantity range 608 to quantity range 610), the method 400 will not be triggered to transmit market depth update information or update the display of market depth quantity range indicators.

Market depth quantity range indicators can be configured to be the same color across all ranges, increasing intensity of color, a pattern, a different color or pattern for the largest quantity range indicator at each price level, or where an indicator blinks Different indicators may be configured at different price levels. Different market depth quantity range indicators can be set for the bid and ask sides. Quantity range indicators may be configured to fade away as market depth falls below the threshold that triggers the display of a particular quantity range.

In other examples, market data and/or a display update can be additionally withheld when a slop parameter is not met or exceeded. The slop parameter can be related to the quantity available or time since last update or both. Slop may be used before transmitting data and updating the display. For example, a slop parameter may be set to require more than one change within a market depth quantity range before updated the market depth quantity range indicators. Instead of updating the market depth quantity indicators immediately, or substantially immediately, after the market depth shifts between market depth quantity ranges, the slop parameter may require a second change within the same market depth quantity range before updating the display. In another embodiment, a slop parameter may be established that operates as a countdown from the time since the last market data update. In this instance, the countdown slop parameter may cause a display update when the time between market data updates exceeds a predefined countdown threshold. In this way, a display update will not be delayed or held in markets that are slow or are otherwise experiencing slow trading volume.

In an additional or alternative example, a slop parameter may be set to require a minimum increase/decrease in market depth quantity. For example, if the slop parameter is set to one-hundred (100) and the jump in market depth quantity is ninety-nine (99), the market data will not be transmitted and the display will not be updated, even though the new market depth quantity falls within a different market depth quantity range. Such slop parameter may be considered a jump slop parameter.

All or some slop parameters can be combined with a time slop parameter. For example, regardless of what other slop parameter is being evaluated, the time slop parameter will only allow the display to be updated when the market depth quantity remains within a market depth quantity range for period of time.

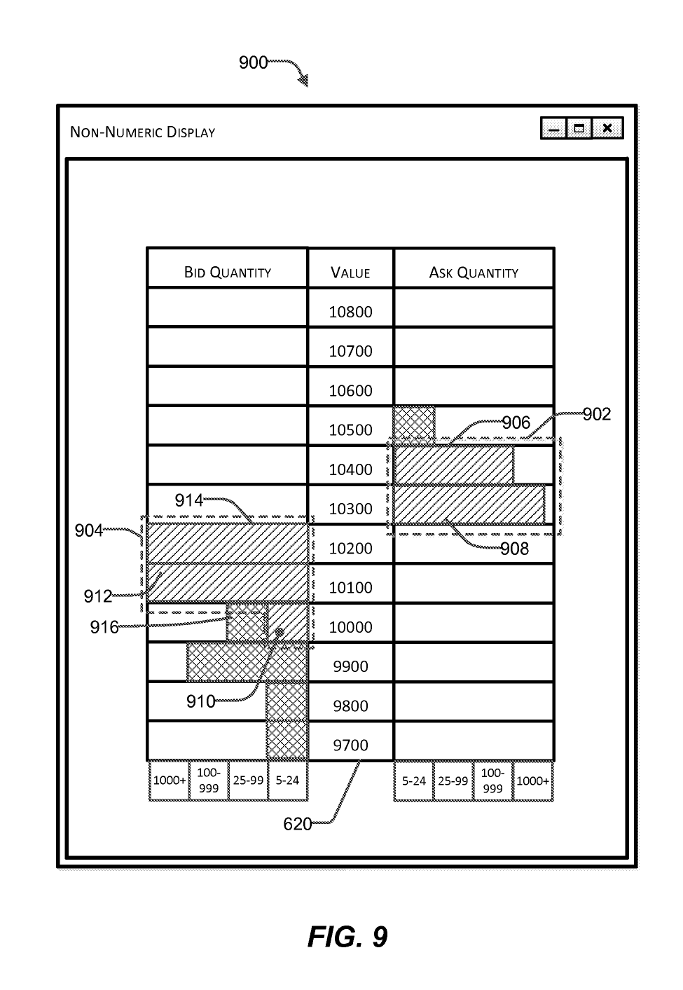

Similarly, market depth change information may not be transmitted or displayed if the market depth change is not stable. For example, a time slop parameter of ten (10) seconds will require that the market depth change fall in a different market depth quantity range and remain in that range for at least ten (10) seconds. This will prevent the display from updating when market depth at an associated price level jumps back and forth between two market depth quantity ranges. For example, market depth information will not be transmitted when the bid quantity 518 of 0 (in FIG. 5A) increases to the bid quantity 520 of 9 (in FIG. 9B), until the new quantity at price level 9700 remains in the same market depth quantity range for a predetermined period of time.

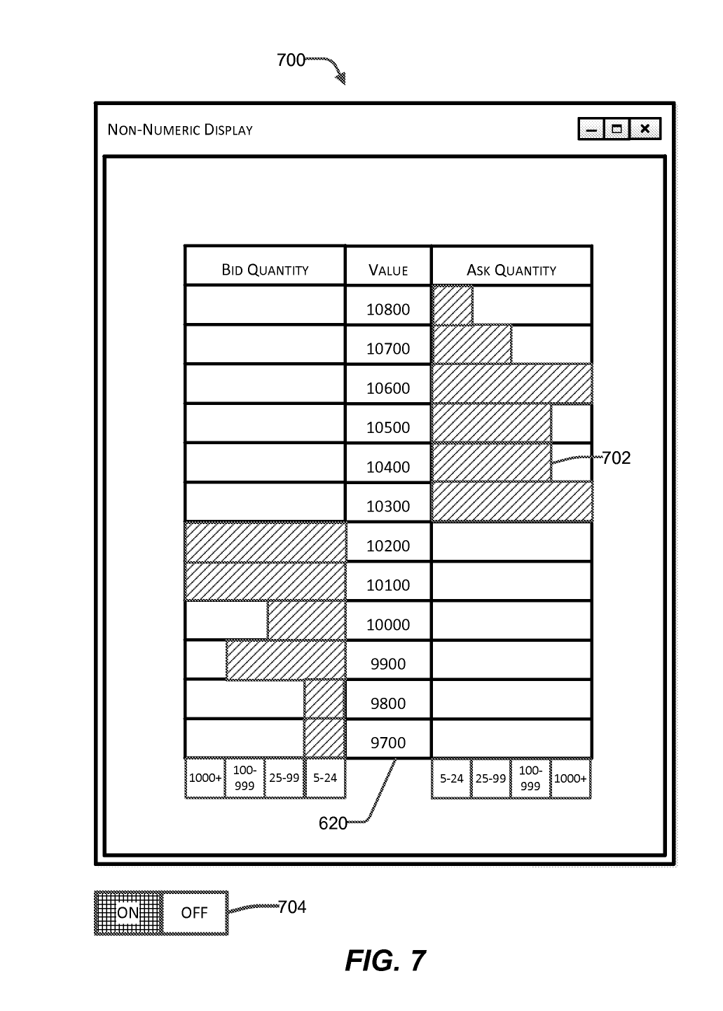

FIG. 7 illustrates non-numeric quantity data feed display 700 having a continuous market depth quantity range indicator 702 that moves between market depth quantity ranges as the market depth quantity shifts between quantity ranges. Additionally, display 700 depicts an “On/Off” toggle 704 to switch between numeric and non-numeric market depth representations and displays. In the illustrated embodiment, quantity information at a given price level is represented by a continuous quantity range indicator. In another embodiment, the continuous market depth quantity range indicator 702 at price level 10400 may have variable pattern or color configured to change intensity or shade in proportion to the available quantity. The price level 10400 is part of the value axis 620 shown in FIGS. 6A and 6B. Features and elements that are common between embodiments are identified using the same reference identifier for the sake of convenience.

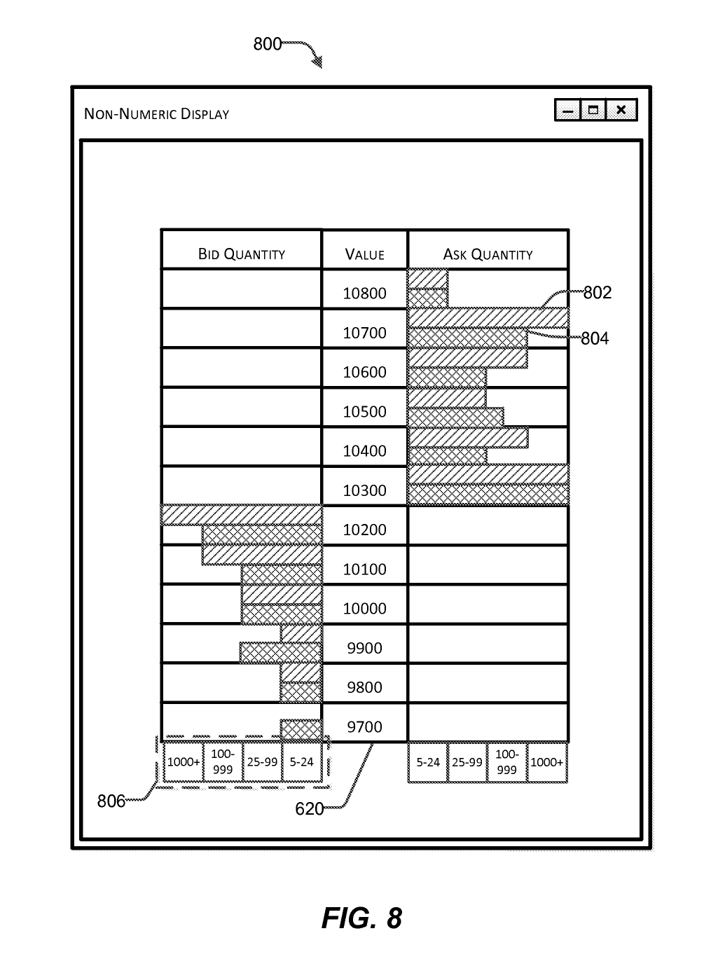

FIG. 8 illustrates an alternate non-numeric quantity data feed display 800 having multiple continuous market depth quantity range indicators 802 and 804. Continuous quantity range indicators 802 and 804 may represent different tradeable objects operable in, for example, a trading strategy. The market depth for multiple tradeable objects may share a common or mathematically normalized and/or derived value axis. Similarly, the lengths of the continuous market depth quantity range indicators 802 and 804 may be scaled relative to each other for the sake of display and visualization. For example, FIG. 8 may show tradeable objects for the legs of a calendar spread. The price axis may be actual or derived. In another embodiment, the market depth quantity range scale 806 may be bifurcated with separate scales for each of the various tradeable objects. Additional continuous market depth quantity range indicators may be utilized for multiple legged trading strategies.

FIG. 9 illustrates another non-numeric quantity data feed display 900 including a first group of market depth quantity range indicators 902 and a second group of market depth quantity range indicators 904 to identify a specific quantity of bid and ask quantities, respectively. In particular, the first group of market depth quantity range indicators 902 includes a first market depth quantity range indicator 906 at price level 10400 and a second market depth quantity range indicator 908 at price level 10300. The price levels 10300 and 10400 are part of the value axis 620 shown in FIGS. 6A and 6B. The first group of market depth quantity range indicators 902 may be formatted and/or configured to indicate the source of the represented ask quantity. In this way, the portion of the available ask quantity associated with a specific user or trader may be identified. In an example, orders associated with a user may span multiple price levels and quantity range indicators. The second group of market depth quantity range indicators 904 includes multiple market depth quantity range indicators 910-914 spanning price levels 10000 to 10200. In the illustrated example, the market depth quantity range indicator 910 represents the portion of the market depth quantity range indicator 916 associated with the second group 904. In other examples, one or more portions of the market depth quantity range indicators 910-914 may be dragged to between price levels as described in U.S. patent application Ser. No. 09/289,550, filed on Apr. 9, 1999, now U.S. Pat. No. 7,212,999, titled “User Interface for an Electronic Trading System.”

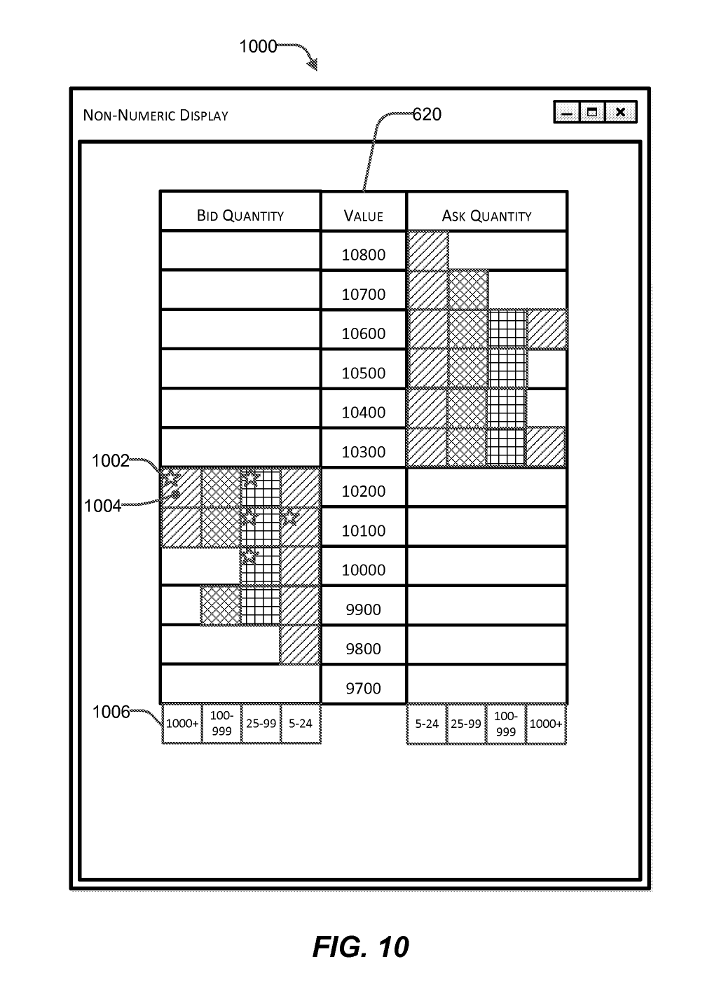

FIG. 10 illustrates another non-numeric quantity data feed display 1000 that includes a queue position indicator 1002. The queue position indicator 1002 provides a visual indication within a market depth quantity range indicator based on the trader's position in queue. For example, a risk manager may want to identify how close an individual trader's orders are to being filled. Those orders that are part of a quantity range closer to the value axis 620, shown in FIGS. 6A and 6B, will be filled earlier. The queue position indicator 1002 associated with the market depth quantity ranges indicator 1004 indicates an available bid quantity of one thousand or more (i.e., as shown by the 1000+ market depth quantity range 1006) at a price level of 10200. The queue position indicators are configurable to any symbol, shape or other indicator that will alert a user to a trader's position in queue.

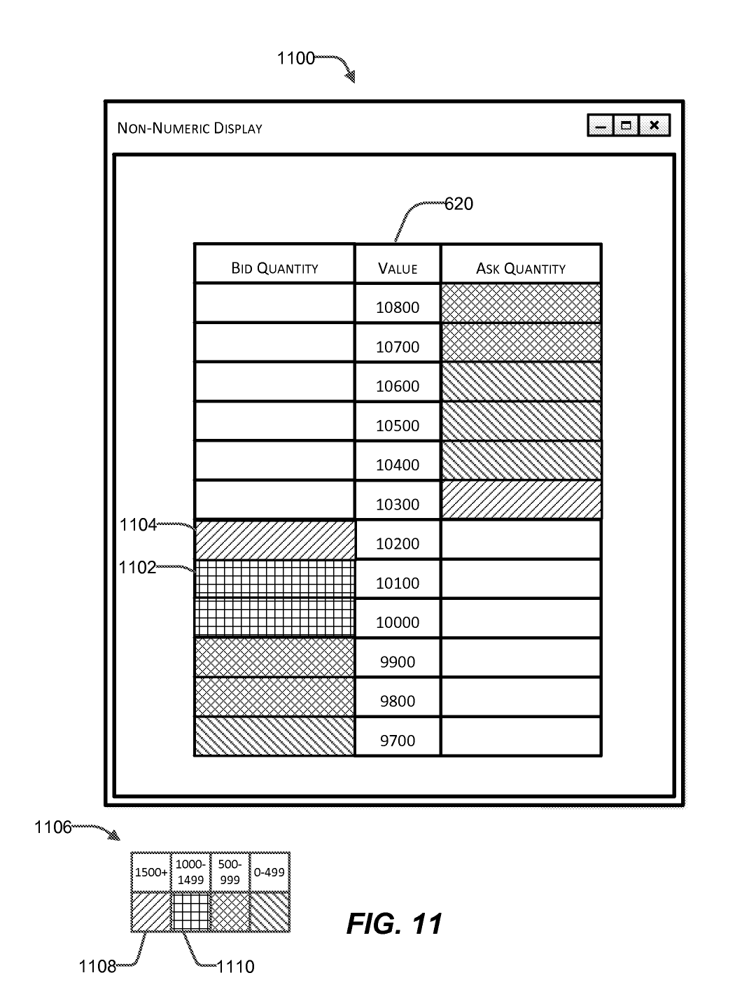

FIG. 11 illustrates another non-numeric quantity data feed display 1100 that utilizes unique market depth quantity range indicators 1102 and 1104 to represent the total available bid quantity at price levels 10100 and 10200, respectively. In this example, the discussed unique market depth quantity range indicators may be utilized to represent the bid quantity and/or the ask quantity. The display 1100 further includes a key or key table 1106 that identifies different market depth quantity range indicators and their respective market depth quantity ranges. For example, the key 1106 includes the quantity range indicator 1108 that, in turn, represents a market depth quantity of at least 1500. Similarly, the quantity range indicator 1110 represents a market depth quantity of 1000-1499. At price level 10200 of the value axis 620, shown in FIGS. 6A and 6B; the market depth quantity range indicator 1104 corresponds to the key 1108 and represents an available market depth quantity of at least 1500. At price level 10100 of the value axis 620, shown in FIGS. 6A and 6B; the market depth quantity range indicator 1102 corresponds to the key 1110 and represents an available market depth quantity within a quantity range of 1000-1499. This configuration of the display 1100 reduces amount of screen real estate needed to display multiple quantity range indicators at a given price level. Alternatively, the market depth quantity range indicators may be different colors for each market depth quantity range, or be a different shade of the same color for each market depth quantity range.

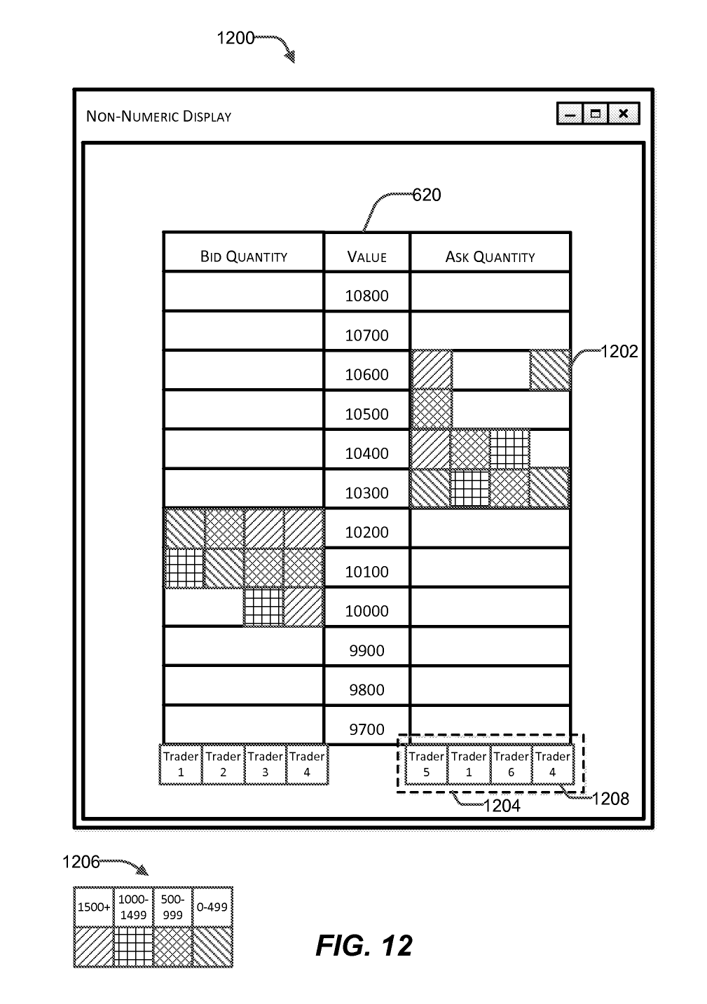

FIG. 12 illustrates another non-numeric quantity data feed display 1200 with order quantity range indicators 1202 arranged to represent and identify order quantity ranges by individual traders, strategies, accounts, or other user-assigned references generally identified by the reference numeral 1204. For example, each position held by an individual trader is displayed at a corresponding price level comprising the value axis 620, shown in FIGS. 6A and 6B. Each of the identified traders 1204 represent a user for which the ask quantity of open orders are to be tracked. A similar header may be used for bid quantity of open orders are to be tracked. The available quantity associated with each trader's working orders is displayed using an order quantity range indicator 1202. A key table or key 1006 identifies different market depth quantity range indicators and their respective market depth quantity ranges. For example, the order quantity range indicator 1202 indicates the available quantity of the orders placed by a trader 1208 at price level 10600 to be between 0-499. The display 1200 of FIG. 12 provides a unified display mechanism that may allow risk manager to quickly and easily monitor the positions of one or more designated traders.

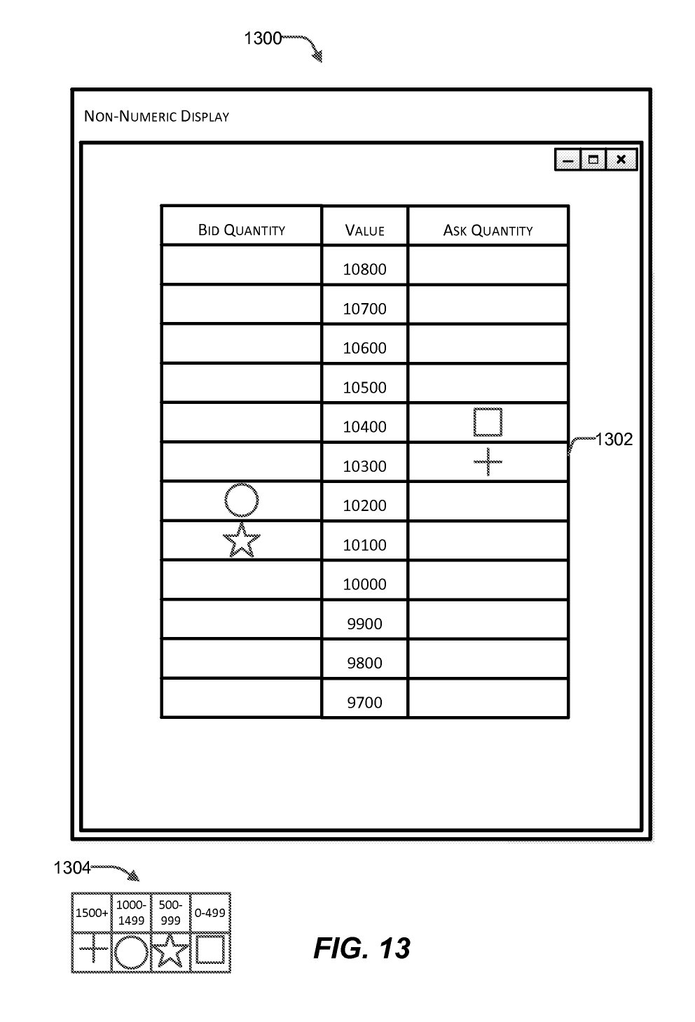

FIG. 13 illustrates another non-numeric quantity data feed display 1300 including a market depth quantity range indicator 1302 at a price level of 10300. The market depth quantity range indicator 1302 represents the market depth at a price level of 10300. In display 1300, the market depth quantity range indicator 1302 is a symbol and/or shape. A key table or key 1304 identifies different market depth quantity range indicators with their respective market depth quantity ranges. For example, the quantity range indicator 1302 at a price level of 10300 represents a market depth of at least 1500.

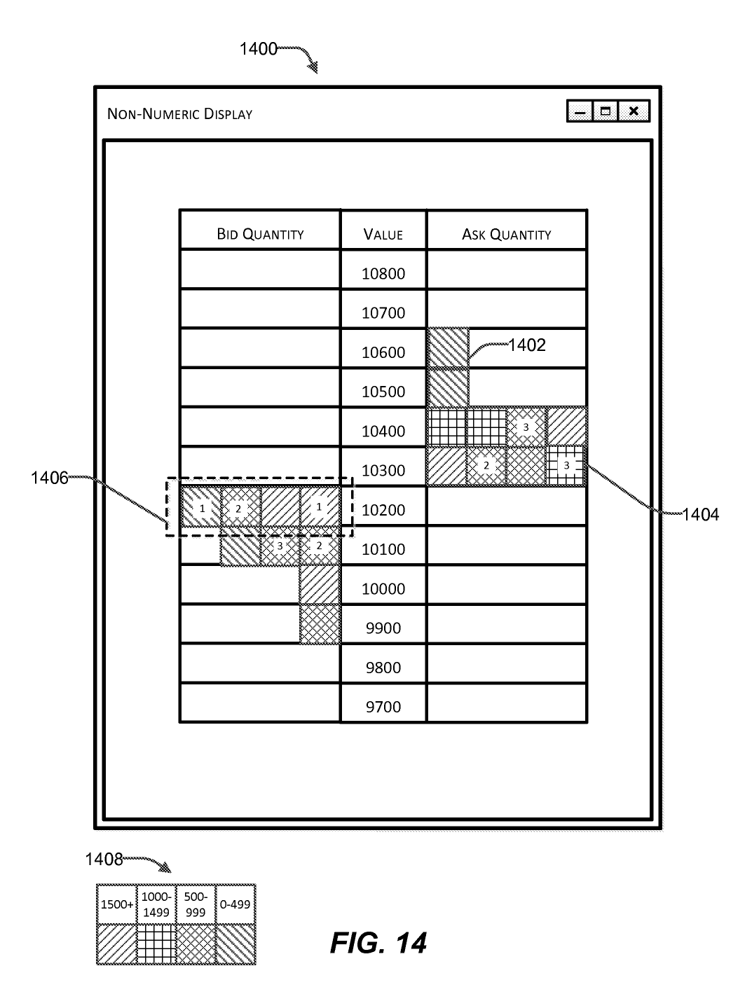

FIG. 14 illustrates another non-numeric quantity data feed display 1400 with market depth divided between internal users and external users. For example, market depth quantity range indicator 1404 uses a “3” to identify that that portion of the market depth consists of orders placed by internal trader “3.” Internal traders are at least one trader, user, strategy, algorithm, or account, for which the display is configured to track. For example, a risk manager may track one or more internal traders such as traders within an organization. The display 1400 can be configured to display the positions of the internal traders being monitored by the risk manager and external traders that are not monitored by the same risk manager. In this example, the portions of the market depth that were not placed by internal traders lack a corresponding trader identifier. For example, a risk administrator can identify market depth quantity range indicator 1402 as being placed by external users because it lacks a trader identifier. An external user generally includes entities that are outside the group of internal users and are not monitored by a common risk manager and/or risk management system. The key table or key 1408 displays the market depth quantity range indicators next to their associated quantity ranges. Trader or user identifiers may be a number, symbol, or anything that can indicate the portion of orders which were placed by an internal user or set of users. Trader or user identifiers may further be utilized to indicate position-in-queue as discussed in connection with FIG. 10. Range indicators 1406 identify four orders at price level 10200. The first and fourth position-in-queue orders use a “1” to identify that those portions of the market depth consist of orders placed by internal trader “1.” The second position-in-queue order can be identified as being placed by external users because it lacks a trader identifier. The third position-in-queue order uses a “2” to identify that those portions of the market depth consist of orders placed by internal trader “2.”

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

1. A method for displaying a market depth for a tradeable object, the method comprising:
displaying, by an electronic display device, a value axis having a plurality of axially aligned price levels associated the tradeable object;
receiving, by a computing device, market depth information associated with the tradeable object, wherein the market depth information includes quantity information describing the available quantity of the tradeable object at each of the plurality of price levels;
comparing, by a computing device, the available quantity at each of the plurality of price levels to at least one quantity threshold parameter, wherein the at least one quantity threshold parameter is associated with a range of tradeable object quantities; and
updating an electronic display device when the available quantity exceeds the quantity threshold parameter, wherein the electronic display device utilizes one or more quantity range indicators positioned adjacent to one or more of the plurality of price levels, and wherein each of the one or more quantity range indicators represents a range of the available quantity.

2. The method as defined in claim 1, wherein the quantity range indicator is selected from the group consisting of: a color; a pattern; and a symbol.

3. The method as defined in claim 1, wherein the quantity range indicator transitions between a highlighted state and a non-highlighted state.

4. The method as defined in claim 3, wherein the highlighted state is a visible state and wherein the non-highlighted state is a non-visible state.

5. The method as defined in claim 1, wherein the quantity range indicator associated with the largest range of tradeable object quantities is unique at a given price level

6. The method as defined in claim 1, wherein the quantity range indicator are configured differently at each price level.

7. The method as defined in claim 1, wherein updating the electronic display device includes evaluating the available quantity with respect to at least one slop parameter.

8. The method as defined in claim 7, wherein the at least one slop parameter is selected from the group consisting of: a quantity slop parameter and a time slop parameter.

9. The method as defined in claim 1, wherein the market depth is displayed for multiple tradeable objects.

10. The method as defined in claim 1, wherein the quantity range indicator includes a user indicator.

11. A method for displaying a market depth for a tradeable object, the method comprising:
displaying, by an electronic display device, a sequence of quantity indicators associated with the tradeable object, wherein the sequence of quantity range indicators is adjacent to a corresponding price level;
setting, by a computing device, a quantity threshold parameter, wherein the quantity threshold parameter is associated the sequence of quantity range indicators;
determining, by the computing device, the quantity threshold parameter is exceeded; and
enabling, by the electronic display device, at least one of the sequence of quantity range indicators associated with the exceeded quantity threshold parameter.

12. The method as defined in claim 11, wherein the quantity range indicator is selected from the group consisting of: a color; a pattern; and a symbol.

13. The method as defined in claim 11, wherein the quantity range indicator associated with the largest range of tradeable object quantities is unique at a given price level

14. The method as defined in claim 11, wherein updating the electronic display device includes evaluating the available quantity with respect to at least one slop parameter.

15. The method as defined in claim 14, wherein the at least one slop parameter is selected from the group consisting of: a quantity slop parameter; a time slop parameter.

16. The method as defined in claim 11, wherein there is at least one quantity range indicator adjacent to each price level.

17. The method as defined in claim 11, further comprising a toggle configured to switch the display between a non-numeric quantity data feed display and a numeric quantity data feed display.

18. A method for displaying a market depth for a tradeable object, the method comprising:
displaying, by an electronic display device, a plurality of axially aligned price levels associated with the tradeable object;
setting, by a computing device, one or more quantity threshold parameters, wherein the one or more quantity threshold parameters are associated with a market depth quantity range;
determining, by the computing device, the one or more quantity threshold parameters are exceeded; and
displaying, by the electronic display device, one or more quantity range indicators adjacent in response to an exceeded quantity threshold parameter, wherein the quantity threshold parameters are associated with the tradeable object at each of the price levels.

19. The method as defined in claim 18, wherein the quantity range indicator is selected from the group consisting of: a color; a pattern; and a symbol.

20. The method as defined in claim 18, wherein the quantity range indicator associated with the largest range of tradeable object quantities is unique at a given price level

21. The method as defined in claim 18, wherein the quantity range indicator are configured differently at each price level.

22. The method as defined in claim 18, wherein updating the electronic display device includes evaluating the available quantity with respect to at least one slop parameter.

23. The method as defined in claim 22, wherein the at least one slop parameter is selected from the group consisting of: a quantity slop parameter, and a time slop parameter.

24. The method as defined in claim 18, wherein there is at least one quantity range indicator adjacent to each price level.

25. The method as defined in claim 18, further comprising a toggle configured to switch the display between a non-numeric quantity data feed display and a numeric quantity data feed display.

26. The method as defined in claim 18, wherein the market depth is displayed for multiple tradeable objects.

27. The method as defined in claim 18, wherein the quantity range indicator includes a user indicator.
